(19) United States
(12) Patent Application Publication
(10) Pub. No.: US 2001/0052040 A1
(43) Pub. Date: Dec. 13, 2001

(54) Data conversion device

(76) Inventors: Masahide Takazawa, Kawasaki (JP); Yukihiro Okada, Kawasaki (JP)

Correspondence Address: STAAS & HALSEY, Suite 500, 700 Eleventh Street, N.W., Washington, DC, 20001, US

(21) Appl. No.: 09/729,313

(22) Filed: Dec. 5, 2000

(30) Foreign Application Priority Data
Dec. 8, 1999 (JP) 11-349453

(51) Int. Cl. G06F 13/38; G06F 13/40

(52) U.S. Cl. 710/100

(57) ABSTRACT

A data conversion device is provided in an information-processing device having an image-display device as an integral part thereof, wherein the information-processing device supplies data to the image-display device through the data conversion device. The data conversion device includes a voltage-level conversion unit converting a voltage level of input data of the data conversion device inputted from the information-processing device to a desired voltage level, and a bit-length conversion unit converting a bit length of the input data to a desired bit length. The data conversion device is implemented on a single semiconductor chip, and is directly connected to the information-processing device without using a data transmission method of transmitting data for a long distance. By use of the data conversion device in an information-processing device that includes a chipset and a monitor, the voltage level and the bit length of the input data, that is, the data outputted from the chipset, can be altered to desired values so that the monitor can accept the data.

### BACKGROUND OF THE INVENTION

1. Field of the Invention

The present invention generally relates to a data-conversion device and an information-processing device. The present invention more particularly relates to a data conversion device supplying digital image data processed by an information-processing device to a monitor, and relates to the information-processing device including such data conversion device.

2. Description of the Related Art

FIG. 1 is a block diagram showing a conventional personal computer. A personal computer 1 includes a processing unit 2, chipsets 3 and 4, a memory 5, a hard-disk drive (HDD) 6, a video card 7, a monitor 8, a peripheral component interconnect (PCI) slot 9, an industry standard architecture (ISA) slot 10, a universal serial bus (USB) port 11, a PCI bus 12, an ISA bus 13 and a USB 14. The processing unit 2 includes a central processing unit (CPU), a secondary cache and the like, and processes data. The chipset 3 called a north bridge is connected to the processing unit 2, the chipset 4, the memory 5, the video card 7 and the PCI slot 9, and exchanges data with each of the above-described units. The chipset 4 called a south bridge is connected to the chipset 3, the HDD 6, the PCI slot 9, the ISA slot 10 and the USB port 11, and exchanges data with each of the above-described units.

The memory 5 includes a semiconductor storage device such as a random access memory (RAM) that supplies data read therefrom and stores data written therein. The memory 5 is used as a working area for the processing unit 2. The HDD 6 stores a program and data therein, and the program. The data stored in the HDD 6 are transferred to the memory 5 when the processing unit 2 uses the data. The video card 7 converts digital image data supplied from the chipset 3 into analog image signals, and supplies the analog image signals to the monitor 8. The PCI slot 9 is connected to the PCI bus 12 that connects the chipsets 3 and 4, and accepts a PCI card based on a PCI standard. The ISA slot 10 is connected to the chipset 4 by the ISA bus 13, and accepts an ISA card based on an ISA standard. The USB port 11 is connected to the chipset 4 by the USB 14, and accepts a device based on a USB standard.

The personal computer 1 uses the video card 7 located between the chipset 3 and the monitor 8 to generate a signal that can be processed by the monitor 8. This video card 7 must include a variety of large-scale integrated circuits (LSI) on a printed circuit board so that a cost of producing the personal computer 1 increases by adding the video card 7 thereto.

FIG. 2 is a block diagram showing another conventional personal computer. A personal computer 15 includes a processing unit 2, a memory 5, a HDD 6, a PCI slot 9, a USB port 11, chipsets 16 and 17, a transmitter 18, a receiver 19, a digital monitor 20, a firmware hub 21 and a digital-audio output port 22. It should be noted that a unit in FIG. 2 having the same number as a unit in FIG. 1 includes the same function as the unit in FIG. 1, and a description of the unit is omitted. The chipset 16 is connected to the processing unit 2, the memory 5, the chipset 17 and the transmitter 18, and exchanges data among the above-described units. The chipset 17 is connected to the HDD 6, the ISA slot 9, the USB port 11, the firmware hub 21 and the digital-audio output port 22, and exchanges data among the above-described units.

The chipset 16 can output digital image data therefrom. The digital image data outputted from the chipset 16 is supplied to the transmitter 18. The transmitter 18 converts a data format of the digital image data supplied from the chipset 16 to a special data format for transmitting to the receiver 19. The digital data outputted from the transmitter 18 is supplied to the receiver 19. Subsequently, the receiver 19 outputs the digital data received from the transmitter 18 in a data format requested by the digital monitor 20. The data format requested by the digital monitor 20 is a data format wherein a data length is 24 bits, and a reference voltage is 3.3 V.

As shown in FIG. 2, a personal computer whereto a monitor is connected by a data transmission path has the data transmission path that is exposed, and thus uses a special data transmission method that protects data transmitted through the path from electromagnetic waves. An example of such data transmission method is a panel link standard. The panel link standard needs a transmitter and a receiver, and thus the transmitter 18 and the receiver 19 are provided in the personal computer 15 based on the panel link standard. The transmitter 18 converts the digital image data supplied from the chipset 16 into a signal based on the panel link standard, and outputs the signal to the data transmission path. Subsequently, the receiver 19 converts the signal received from the transmitter 18 through the data transmission path into digital data that has a voltage level and a data bit length requested by the digital monitor 20.

On the other hand, a personal computer that has a monitor as an integral part thereof does not need to transmit digital image data to a monitor located outside the personal computer through the data transmission path, and distance to transmit the digital image data is shorter than that of the personal computer with the monitor located outside the personal computer. Accordingly, the personal computer that includes the monitor does not need any special data transmission method to transmit the digital image data to the monitor. In such conventional personal computer, however, a voltage level and a data bit length are different between digital image data outputted from a chipset and digital image data requested by a monitor to be inputted, so that the digital image data outputted from the chipset cannot be inputted to the monitor without any data conversion.

Accordingly, the personal computer that has a monitor integrated therein transmits digital image data to the monitor by use of the panel link standard in the same manner as does the personal computer having a separate monitor. Therefore, the personal computer that includes the monitor needs to include two kinds of extra integrated circuits (IC), i.e., a transmitter and a receiver, which are expensive and are exclusively used for the panel link standard. Consequently, the cost of producing the personal computer that includes the monitor increases by having the transmitter and the receiver therein.

### SUMMARY OF THE INVENTION

Accordingly, it is a general object of the present invention to provide a data conversion device connecting a chipset and a monitor provided in an information-processing device with a structure of the data conversion device being simple. A more particular object of the present invention is to provide a data conversion device converting a voltage level and a bit length of data outputted from a chipset provided in an information-processing device respectively to a desired voltage level and a desired bit length so that the data can be received by a monitor provided in the information-processing device.

The above-described object of the present invention is achieved by a data conversion device provided in an information-processing device having an image-display device as an integral part thereof, wherein the information-processing device supplies data to the image-display device through the data conversion device, the data conversion device including a voltage-level conversion unit converting a voltage level of input data of the data conversion device inputted from the information-processing device to a desired voltage level, and a bit-length conversion unit converting a bit length of the input data to a desired bit length, wherein the data conversion device is implemented on a single semiconductor chip, and is directly connected to the information-processing device without using a data transmission method of transmitting data for a long distance.

By use of the data conversion device, the voltage level and the bit length of the input data, that is, the data outputted from the chipset, can be altered to desired values so that the monitor can accept the data.

Other objects, features and advantages of the present invention will become more apparent from the following detailed description when read in conjunction with the accompanying drawings.

### BRIEF DESCRIPTION OF THE DRAWINGS

FIG. 1 is a block diagram showing a conventional personal computer 1;

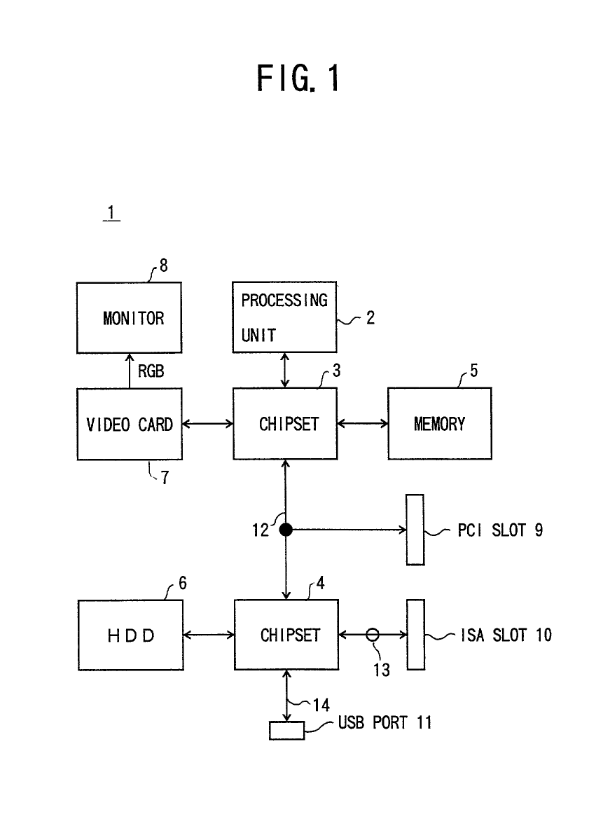

FIG. 2 is a block diagram showing conventional personal computer 15;

FIG. 3 is a block diagram showing an information-processing device 100 according to an embodiment of the present invention;

FIG. 4 is a block diagram showing a data-conversion device 102 according the embodiment of the present invention;

FIG. 5 is a graph showing a first mode for storing input data in registers 116 and 117;

FIG. 6 is a graph showing a second mode for storing the input data in registers 118 and 119;

FIG. 7 is a graph showing a third mode for storing the input data in registers 120 and 121; and

FIG. 8 is a graph showing a fourth mode for storing the input data in registers 122 and 123.

### DESCRIPTION OF THE PREFERRED EMBODIMENTS

A description will now be given of preferred embodiments of the present invention, with reference to the accompanying drawings.

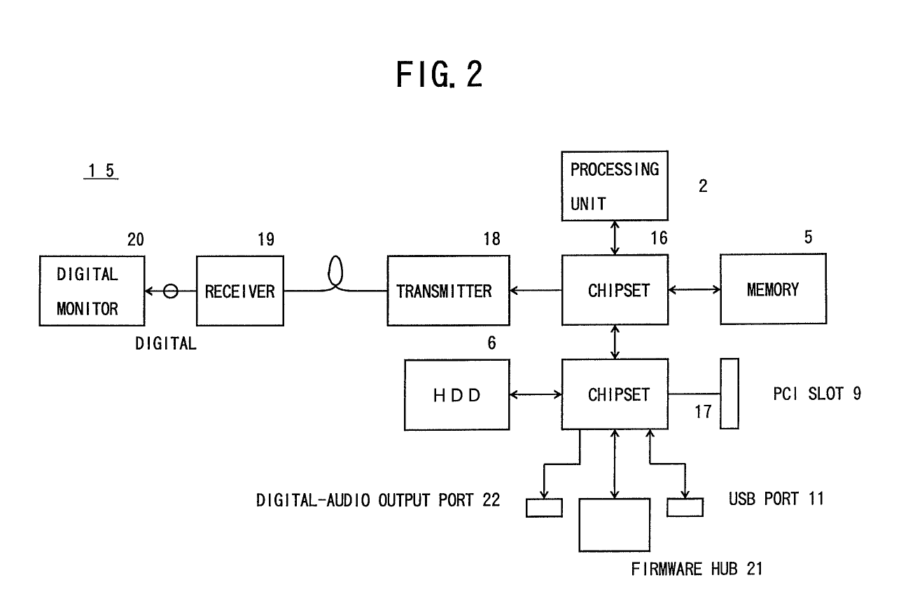

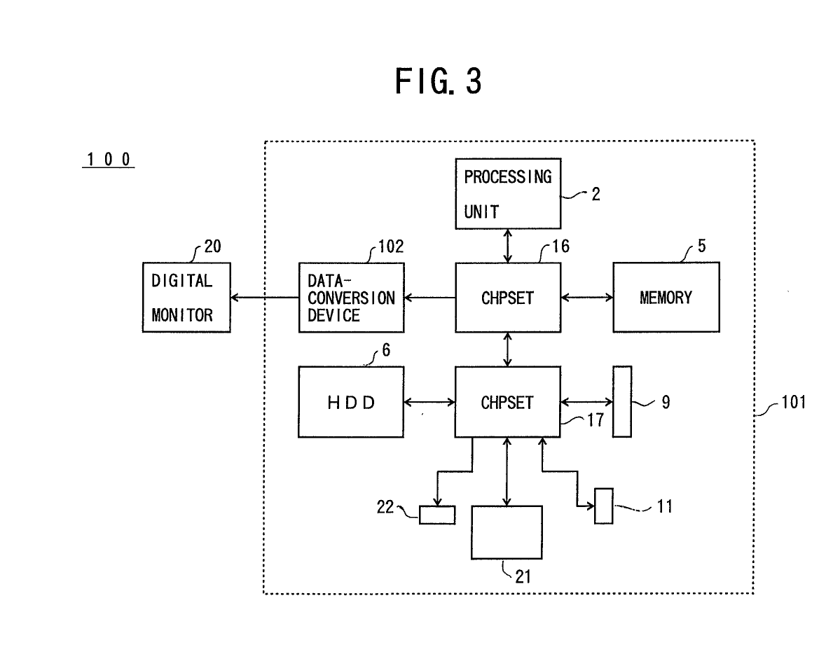

FIG. 3 is a block diagram showing an information-processing device according to an embodiment of the present invention. It should be noted that a unit in FIG. 3 having the same number as a unit in FIG. 2 includes the same function as that unit in FIG. 2, and a description thereof will be omitted.

An information-processing device 100 shown in FIG. 3 is a personal computer including a computing unit 101 and a digital monitor 20. The computing unit 101 includes a processing unit 2, a memory 5, a HDD 6, a PCI slot 9, a USB port 11, chipsets 16 and 17, a firmware hub 21, a digital-audio output port 22 and a data-conversion device 102. The digital monitor 20 is connected to the computing unit 101 through the data-conversion device 102. The data-conversion device 102 is on a single semiconductor chip, and converts digital data outputted from the chipset 16 to digital data having a voltage level and a data bit length requested by the digital monitor 20.

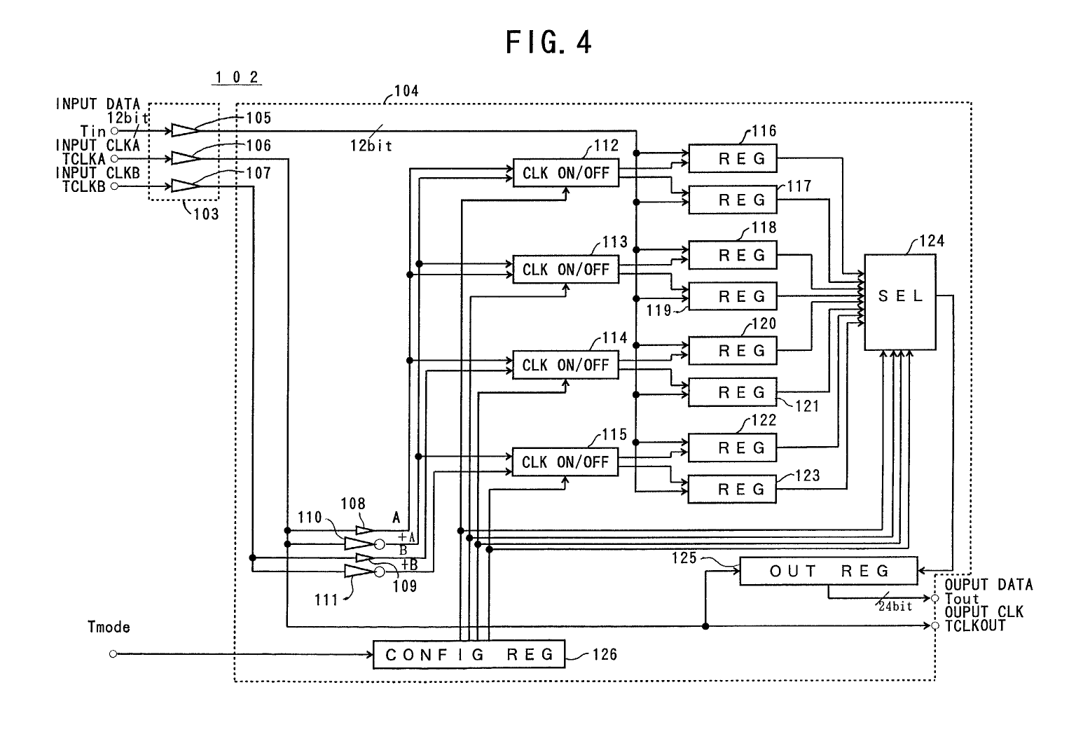

FIG. 4 is a block diagram showing a structure of the data-conversion device 102 according to the embodiment of the present invention. The data-conversion device 102 includes a data-input terminal Tin, clock-input terminals TCLKA and TCLKB, a data-output terminal Tout, a clock-output terminal TCLKOUT, a mode-selecting terminal Tmode, a voltage-level conversion unit 103 and a bit-length conversion unit 104. The voltage-level conversion unit 103 includes buffer amplifiers 105, 106 and 107. The bit-length conversion unit 104 includes buffers 108 and 109, inverting buffers 110 and 111, switching circuits 112 through 115, registers (REG) 116 through 123, a selector (SEL) 124, an output register (OUT REG) 125 and a configuration register (CONFIG REG) 126.

The data-input terminal Tin is connected to the chipset 16, and is supplied with 12-bit parallel digital data with its reference voltage being set to 1.8V from the chipset 16. The data-input terminal Tin then outputs the data supplied from the chipset 16 to the buffer amplifier 105. The clock-input terminal TCLKA is connected to the chipset 16, and is supplied with a 1-bit clock signal CLKA with its reference voltage being set to 1.8V, that is synchronous to the digital data inputted to the data-input terminal Tin, from the chipset 16. The clock-input terminal TCLKA then outputs the clock signal CLKA to the buffer amplifier 106. It should be noted that the 12-bit parallel digital data is supplied from the chipset 16 to the data-input terminal Tin at a rising edge and a falling edge of the clock signal CLKA. The clock-input terminal TCLKB is also connected to the chipset 16, and is supplied with a 1-bit clock signal CLKB with its reference voltage being set to 1.8V, that is the inverse of the clock signal CLKA. The clock-input terminal TCLKB then outputs the clock signal CLKB to the buffer amplifier 107.

The data-output terminal Tout is connected to the digital monitor 20, and outputs 24-bit parallel digital data with its reference voltage being set to 3.3V to the digital monitor 20. The clock-output terminal TCLKOUT is connected to the clock-input terminal TCLKA and the digital monitor 20, and outputs 1-bit digital data, that is, the clock signal CLKA from the clock-input terminal TCLKA to the digital monitor 20. The mode-selecting terminal Tmode is connected to the chipset 16 and to other control units not shown in FIG. 4, and is supplied with 4-bit serial digital data therefrom.

A description will now be given of the voltage-level conversion unit 103.

The buffer amplifier 105 located in the voltage-level conversion unit 103 is connected to the data-input terminal Tin. The buffer amplifier 105 is supplied with the 12-bit parallel digital data with its reference voltage being set to 1.8V from the data-input terminal Tin, and converts the reference voltage of the 12-bit parallel digital data from 1.8V to 3.3V. Similarly, the buffer amplifier 106 connected to the clock-input terminal TCLKA converts the reference voltage of the clock signal CLKA supplied from the clock-input terminal TCLKA from 1.8V to 3.3V. Additionally, the buffer amplifier 107 connected to the clock-input terminal TCLKB converts the reference voltage of the clock signal CLKB supplied from the clock-input terminal TCLKB from 1.8V to 3.3V. The data from the buffer amplifier 105, the clock signal CLKA from the buffer amplifier 106 and the clock signal CLKB from the buffer amplifier 107 are supplied to the bit-length conversion unit 104 with their reference voltages being converted from 1.8V to 3.3V.

A description will now be given of the bit-length conversion unit 104.

The buffer 108 receives the clock signal CLKA from the buffer amplifier 106, amplifies the clock signal CLKA, and then outputs the amplified clock signal CLKA to the switching circuits 112, 113 and 114. The buffer 109 receives the clock signal CLKB from the buffer amplifier 107, amplifies the clock signal CLKB, and then outputs the amplified clock signal CLKB to the switching circuit 114. The inverting buffer 110 inverts and amplifies the clock signal CLKA received from the buffer amplifier 106. The inverting buffer 110 then outputs the inverted and amplified clock signal CLKA as a clock signal CLKA_NOT to the switching circuits 112, 113 and 115. The inverting buffer 111 inverts and amplifies the clock signal CLKB received from the buffer amplifier 107. Subsequently, the inverting buffer 111 outputs the inverted and amplified clock signal CLKB as a clock signal CLKB_NOT to the switching circuit 115.

The switching circuit 112 connected to the buffer 108, the inverting buffer 110 and the configuration register 126 receives the clock signal CLKA from the buffer 108, the clock signal CKLA_NOT from the inverting buffer 110 and a 1-bit signal from the configuration register 126. The switching circuit 112 is activated and outputs the clock signal CLKA to the register 116 and the clock signal CLKA_NOT to the register 117 if it receives a 1-bit signal set to “1” from the configuration register 126. If the 1-bit signal supplied from the configuration register 126 is set to “0”, the switching circuit 112 is deactivated and does not output the clock signal CLKA and the clock signal CLKA_NOT respectively to the register 116 and the register 117.

The switching circuit 113 connected to the buffer 108, the inverting buffer 110 and the configuration register 126 receives the clock signal CLKA from the buffer 108, the clock signal CKLA_NOT from the inverting buffer 110 and a 1-bit signal from the configuration register 126. The switching circuit 113 is activated and outputs the clock signal CLKA_NOT to the register 118 and the clock signal CLKA to the register 119 if it receives a 1-bit signal set to “1” from the configuration register 126. If the 1-bit signal supplied from the configuration register 126 is set to “0”, the switching circuit 113 is deactivated and does not output the clock signal CLKA_NOT and the clock signal CLKA respectively to the register 118 and the register 119.

The switching circuit 114 connected to the buffer 108, the buffer 109 and the configuration register 126 receives the clock signal CLKA from the buffer 108, the clock signal CKLB from the buffer 109 and a 1-bit signal from the configuration register 126. The switching circuit 114 is activated and outputs the clock signal CLKA to the register 120 and the clock signal CLKB to the register 121 if it receives a 1-bit signal set to “1” from the configuration register 126. If the 1-bit signal supplied from the configuration register 126 is set to “0”, the switching circuit 114 is deactivated and does not output the clock signal CLKA and the clock signal CLKB respectively to the register 120 and the register 121.

The switching circuit 115 connected to the inverting buffer 110, the inverting buffer 111 and the configuration register 126 receives the clock signal CLKA_NOT from the inverting buffer 110, the clock signal CKLB_NOT from the inverting buffer 111 and a 1-bit signal from the configuration register 126. The switching circuit 115 is activated and outputs the clock signal CLKA_NOT to the register 122 and the clock signal CLKB_NOT to the register 123 if it receives a 1-bit signal set to “1” from the configuration register 126. If the 1-bit signal supplied from the configuration register 126 is set to “0”, the switching circuit 115 is deactivated and does not output the clock signal CLKA_NOT and the clock signal CLKB_NOT respectively to the register 122 and the register 123.

The register 116 stores the 12-bit parallel digital data supplied from the buffer amplifier 105 at a rising edge of the clock signal CLKA supplied from the switching circuit 112. The register 117 stores the 12-bit parallel digital data supplied from the buffer amplifier 105 at a rising edge of the clock signal CLKA_NOT supplied from the switching circuit 112. The register 118 stores the 12-bit parallel digital data supplied from the buffer amplifier 105 at the rising edge of the clock signal CLKA_NOT supplied from the switching circuit 113. The register 119 stores the 12-bit parallel digital data supplied from the buffer amplifier 105 at the rising edge of the clock signal CLKA supplied from the switching circuit 113. The register 120 stores the 12-bit parallel digital data supplied from the buffer amplifier 105 at the rising edge of the clock signal CLKA supplied from the switching circuit 114. The register 121 stores the 12-bit parallel digital data supplied from the buffer amplifier 105 at a rising edge of the clock signal CLKB supplied from the switching circuit 114. The register 122 stores the 12-bit parallel digital data supplied from the buffer amplifier 105 at the rising edge of the clock signal CLKA_NOT supplied from the switching circuit 115. The register 123 stores the 12-bit parallel digital data supplied from the buffer amplifier 105 at a rising edge of the clock signal CLKB_NOT supplied from the switching circuit 115. It should be noted that the registers 116 through 123 include latch registers.

The configuration register 126 receives 4-bit serial digital data from the mode-selecting terminal Tmode as a mode-set value. Each of the most significant bit, the second most significant bit, the second least significant bit and the least significant bit in the mode-set value corresponds to the 1-bit signal supplied respectively to the switching circuits 112, 113, 114 and 115.

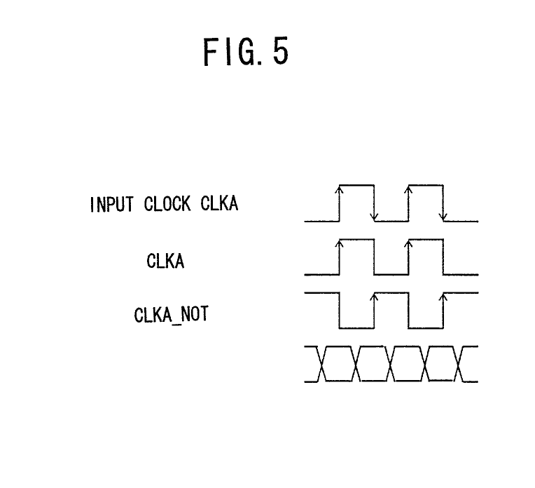

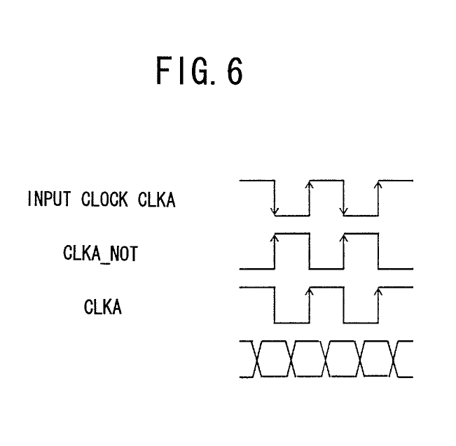

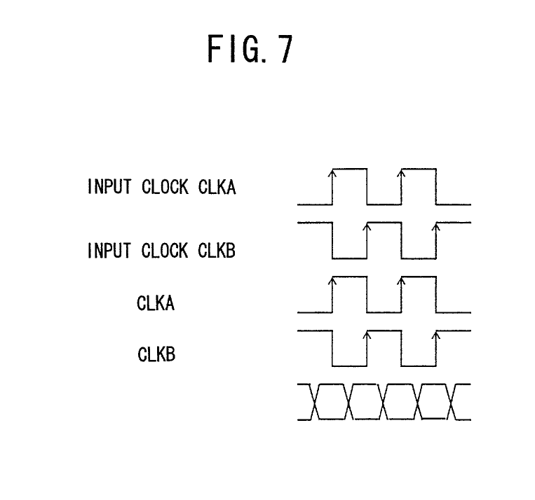

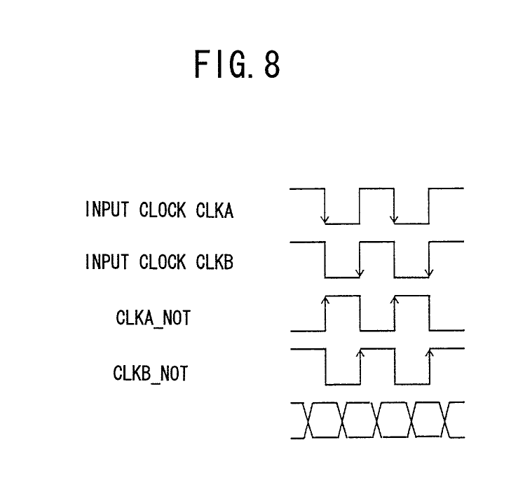

Thus, when the mode-set value is “1000”, digital data supplied from the buffer amplifier 105 at the rising edge of the clock signal CLKA is stored in the register 116 at the rising edge of the clock signal CLKA, and digital data supplied from the buffer amplifier 105 at the falling edge of the clock signal CLKA is stored in the register 117 at the rising edge of the clock signal CLKA_NOT, as shown in FIG. 5. When the mode-set value is “0100”, the digital data supplied from the buffer amplifier 105 at the falling edge of the clock signal CLKA is stored in the register 118 at the rising edge of the clock signal CLKA_NOT, and the digital data supplied from the buffer amplifier 105 at the rising edge of the clock signal CLKA is stored in the register 119 at the rising edge of the CLKA, as shown in FIG. 6. When the mode-set value is “0010”, the digital data supplied from the buffer amplifier 105 at the rising edge of the clock signal CLKA is stored in the register 120 at the rising edge of the clock signal CLKA, and the digital data supplied from the buffer amplifier 105 at the falling edge of the clock signal CLKA is stored in the register 121 at the rising edge of the clock signal CLKB, as shown in FIG. 7. Additionally, when the mode-set value is “0001”, the digital data supplied from the buffer amplifier 105 at the falling edge of the clock signal CLKA is stored in the register 122 at the rising edge of the clock signal CLKA_NOT, and the digital data supplied from the buffer amplifier 105 at the rising edge of the clock signal CLKA is stored in the register 123 at the rising edge of the clock signal CLKB_NOT, as shown in FIG. 8.

The digital data stored in the registers 116 through 123 is supplied to the selector 124. The selector 124 selects the digital data to be outputted to the output register 125 according to the mode-set value supplied from the configuration register 126. For instance, the selector 124 outputs the digital data stored in the registers 116 and 117 to the output register 125 if the mode-set value is “1000”. The selector 125 outputs the digital data stored in the registers 118 and 119 to the output register 125 if the mode-set value is “0100”. If the mode-set value is “0010”, the selector 124 outputs the digital data stored in the registers 120 and 121 to the output register 125. If the mode-set value is “0001”, the selector 124 outputs the digital data stored in the registers 122 and 123 to the output register 125.

The output register 125 is supplied with digital data selected by the selector 124, and the clock signal CLKA from the buffer amplifier 106. The output register 125 stores digital data with its data length being 24 bits, that is a combination of the 12-bit digital data supplied from two of the registers 116 through 123. The output register 125 outputs 24-bit digital data to the digital monitor 20 at the rising edge of the clock signal CLKA.

In order to explain about the digital data stored in the output register 125, the digital data supplied from the buffer amplifier 105 to one of the registers 116 through 123 at the rising edge of the clock signal CLKA is referred to as data 1. Additionally, the digital data supplied from the buffer amplifier 105 to one of the registers 116 through 123 at the falling edge of the clock signal CLKA is referred to as data 2. When the mode-set value is “1000”, the registers 116 and 117 respectively store the data 1 and the data 2, and thus the output register 125 stores 24-bit data that consists of the data 1 as a higher 12-bit part of the 24-bit data and the data 2 as a lower 12-bit part of the 24-bit data. When the mode-set value is “0100”, the registers 118 and 119 respectively store the data 2 and the data 1, and thus the output register 125 stores 24-bit data that consists of the data 2 as the higher 12-bit part of the 24-bit data and the data 1 as the lower 12-bit part of the 24-bit data. Similarly, when the mode-set value is “0010”, the registers 120 and 121 respectively store the data 1 and the data 2, and thus the output register 125 stores the 24-bit data that includes the data 1 as the higher 12-bit part of the 24-bit data and the data 2 as the lower 12-bit part of the 24-bit data. When the mode-set value is “0001”, the registers 122 and 123 respectively store the data 2 and the data 1, and thus the output register 125 stores the 24-bit data that consists of the data 2 as the higher 12-bit part of the 24-bit data and the data 1 as the lower 12-bit part of the 24-bit data.

The bit-length conversion unit 104 includes a combination of the registers 116 and 117, and a combination of the registers 120 and 121 so that one of the combinations can be selected by use of the mode-set value to output correct data to the output register 125 in a case that an error has occurred on data stored in the other combination, the error being caused by, for instance, noises on the clock signals CLKA and CLKB supplied from the chipset 16, and time lags that occur on the rising edges and the falling edges of the clock signals CLKA and CLKB. Similarly, a combination of the registers 118 and 119 and a combination of the registers 122 and 123 are provided in the bit-length conversion unit 104.

As described above, the voltage-level conversion unit 103 provided in the data-conversion unit 102 converts the voltage level of the digital data inputted to the data-conversion unit 102 from 1.8V to 3.3V. Additionally, the bit-length conversion unit 104 provided in the data-conversion unit 102 coverts the bit length of the digital data inputted to the data-conversion unit 102 from 12 bits to 24 bits. Accordingly, the data-conversion unit 102 can obtain digital data with its reference voltage set to 3.3V and its data length set to 24 bits that are requested by the digital monitor 20.

According to the present invention, the data-conversion device 102 can connect devices that input and output data in different data lengths with different standard voltage levels by converting their data lengths and standard voltage levels to respectively desired data lengths and desired standard voltage levels. A simply structured bit-length conversion unit 104 and a simply structured voltage-level conversion unit 103 can alter a data length and a reference voltage of digital data inputted to the data-conversion unit 102, respectively. By including the voltage-level conversion unit 103 and the bit-length conversion unit 104 in the data-conversion unit 102 on a single semiconductor chip, a structure of the data-conversion device 102 can be simplified, and thus the cost of producing the data-conversion device 102 can be reduced. Furthermore, a chipset and a digital monitor can be connected by use of the single semiconductor chip. Accordingly, a personal computer including the digital monitor therein can connect the chipset provided therein and the monitor at a low cost, for instance. By use of clock signals supplied with digital data from the chipset 16, timing to store the digital data in the registers provided in the data-conversion unit 102 and to output the digital data from the data-conversion unit 102 can be controlled with a simple structure of the data-conversion unit 102.

The above description is provided in order to enable any person skilled in the art to make and use the invention and sets forth the best mode contemplated by the inventors of carrying out the invention.

The present invention is not limited to the specially disclosed embodiments and variations, and modifications may be made without departing from the scope and spirit of the invention.

The present application is based on Japanese Priority Application No. 11-349453, filed on Dec. 8, 1999, the entire contents of which are hereby incorporated by reference.

What is claimed is:

1. A data conversion device provided in an information-processing device having an image-display device as an integral part thereof, wherein the information-processing device supplies data to the image-display device through said data conversion device, said data conversion device comprising:
a voltage-level conversion unit converting a voltage level of input data of said data conversion device inputted from the information-processing device to a desired voltage level; and
a bit-length conversion unit converting a bit length of said input data to a desired bit length,
wherein said data conversion device is implemented on a single semiconductor chip, and is directly connected to the information-processing device without using a data transmission method of transmitting data for a long distance.

2. The data conversion device as claimed in claim 1, wherein said bit-length conversion unit includes a plurality of data storage units storing the input data in an order, and a data-adding unit combining the input data stored in said data storage units.

3. The data conversion device as claimed in claim 1, wherein said bit-length conversion unit is supplied with a first clock synchronous to the input data and a second clock which phase is inverse of a phase of the first clock,
said bit-length conversion unit comprising:
a first data storage unit storing the input data;
a second data storage unit storing the input data;
a timing-control unit controlling timing to store the input data in said first data storage unit and in said second data storage unit depending on the first clock and the second clock; and
a data-combining unit combining the input data stored in said first data storage unit and the input data stored in said second data storage unit.

4. An information-processing device comprising:
a data conversion unit converting first data in a first data length with a first reference voltage to second data in a second data length with a second reference voltage;
a data output unit outputting the first data in the first data length with the first reference voltage directly to said data conversion unit without using a data transmission method of transmitting data for a long distance; and
a digital monitor accepting the second data in the second data length with the second reference voltage from said data conversion unit,
wherein said data conversion unit is implemented on a single semiconductor chip.

5. The information-processing device as claimed in claim 4, wherein said data conversion unit includes a voltage-level conversion unit converting the first reference voltage to the second reference voltage, and a bit-length conversion unit converting the first data length to the second data length.
